(19) United States
(12) Patent Application Publication
(10) Pub. No.: US 2023/0373028 A1
(43) Pub. Date: Nov. 23, 2023

(54) APPARATUS AND METHOD FOR SEMICONDUCTOR PACKAGE FAILURE ANALYSIS

(71) Applicant: Gatan, Inc., Pleasanton, CA (US)

(72) Inventors: Steven Thomas COYLE, Alameda, CA (US); Thijs C. HOSMAN, San Francisco, CA (US); John Andrew HUNT, Fremont, CA (US); Michael Patrick HASSEL-SHEARER, Wilmington, NC (US)

(73) Assignee: Gatan, Inc., Pleasanton, CA (US)

(21) Appl. No.: 18/029,682

(22) PCT Filed: Oct. 8, 2021
(86) PCT No.: PCT/US2021/054147

§ 371 Date: Mar. 31, 2023

Related U.S. Application Data
(60) Provisional application No. 63/089,812, filed on Oct. 9, 2020.

(51) Int. Cl. B23K 26/082; B23K 26/03; B23K 26/06; B23K 26/08; B23K 26/122; B23K 26/16

(52) U.S. Cl. CPC B23K 26/082; B23K 26/032; B23K 26/0648; B23K 26/0861; B23K 26/122; B23K 26/16; B23K 26/0665

(57) ABSTRACT

A pulsed laser apparatus for milling a sample is described. The apparatus includes a pulsed laser, a scan head for scanning a beam from the pulsed laser across the sample an F-theta lens for focusing the scanned beam onto the sample and a confocal detector for detection of ablation depth. Methods of pulsed laser milling are also described.

### CROSS REFERENCE TO RELATED APPLICATIONS

This PCT application claims priority to U.S. Provisional Application No. 63/089,812, filed on Oct. 9, 2020 and titled Apparatus and Method for Semiconductor Package Failure Analysis, the entire disclosure of which is incorporated here by reference.

### BACKGROUND

Ever-increasing semiconductor density requirements have led to devices termed “advanced packages,” which consist of multiple integrated circuits housed within a single package. These packages are becoming a preferred alternative to increased density on individual microcircuits. Advanced packages are also being used in mobile devices where ultra-thin packages with increased functionality are required.

Integrating multiple die in a single package introduces different process development issues and failure modes compared to a single device per package. These include interconnect failures between silicon devices due to metallurgy associated with interdiffusion and brittle phase formation; cracks in through-silicon via insulator sleeves causing shorts to the silicon; stress in the devices causing delamination of the devices as they bow pulling apart the stack devices; overheating; and misalignment of the interconnects. In some cases, packaging houses are not stacking die but stacking wafers and dicing after the completion of the stacking process. In this case, small misalignments from the center of the wafer stack become large toward the edge of the wafer.

Identification of the root cause of many of the above failure modes requires point cross sectioning the package. Many traditional failure analysis techniques cannot, however, make cross sections in advanced packages that can be as large as 50 mm×50 mm and 6 mm thick.

For example, focused ion beam (FIB) (Ga or Plasma) cannot cross section depths greater than a few 100 microns, let alone the depths that may be required to find the root cause of the failure in an advanced package. Broad Argon Beam tools lack the current to produce lengths >10 mm and depths >2 mm polished regions in reasonable times. The only current solution is a slow speed, low damage saw. However, this technique often produces delamination and cracks due to the stresses and dissimilar materials present.

### BRIEF DESCRIPTION OF THE DRAWINGS

FIG. 1A is a block diagram showing a portion of a pulsed laser sample ablation system consistent with implementations described herein;

FIG. 1B is a diagram showing a further portion of the pulsed laser sample ablation system of FIG. 1A;

FIG. 1C is a detailed diagram of portions of the pulsed laser sample ablation system of FIGS. 1A and 1B;

FIG. 1D is a detailed diagram of portions of the pulsed laser sample ablation system of FIGS. 1A and 1B; and

FIG. 2 is a flow diagram for an exemplary ablation process with in-process confocal measurement of ablation depth.

### DETAILED DESCRIPTION OF PREFERRED EMBODIMENTS

Those skilled in the art will recognize other detailed designs and methods that can be developed employing the teachings of the present invention. The examples provided here are illustrative and do not limit the scope of the invention, which is defined by the attached claims. The following detailed description refers to the accompanying drawings. The same reference numbers in different drawings may identify the same or similar elements.

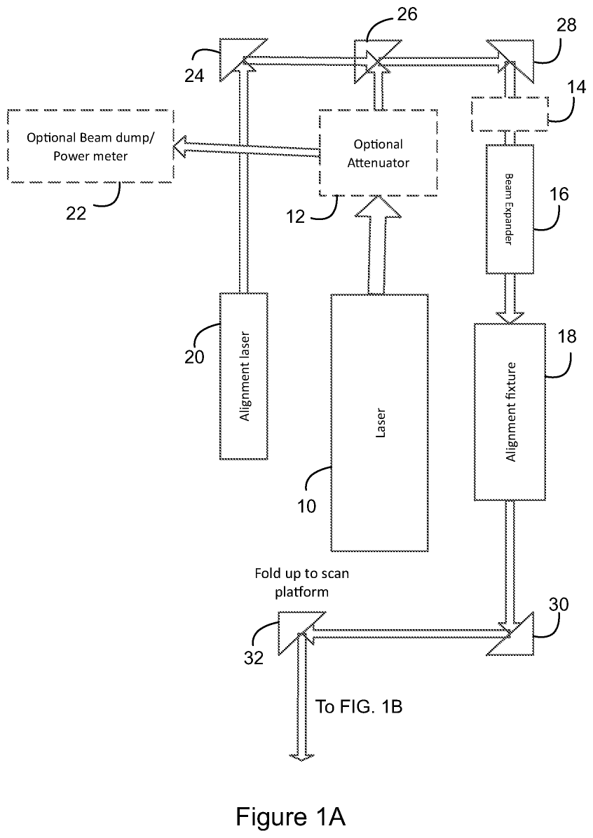

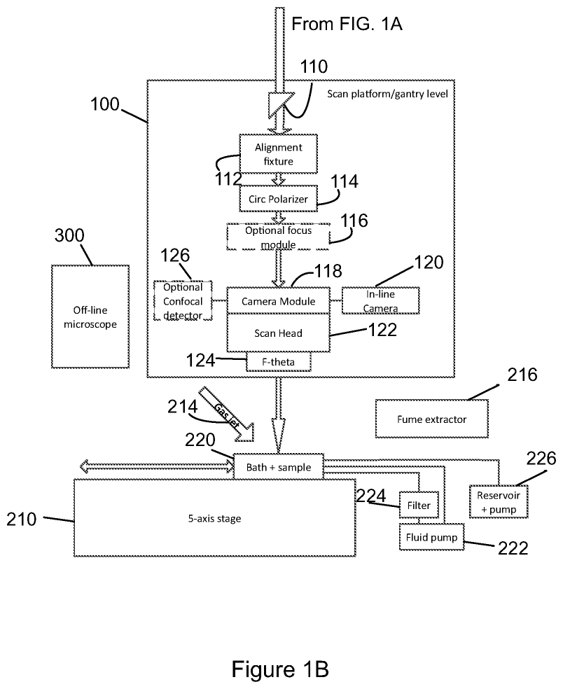

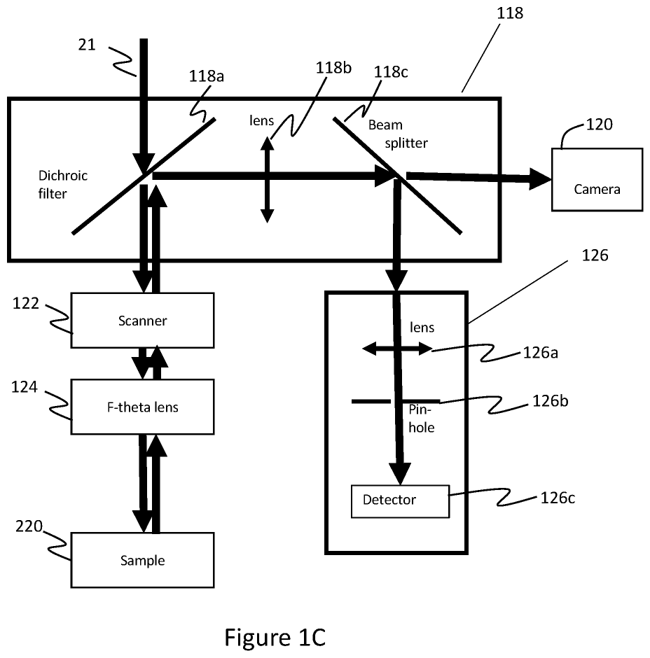

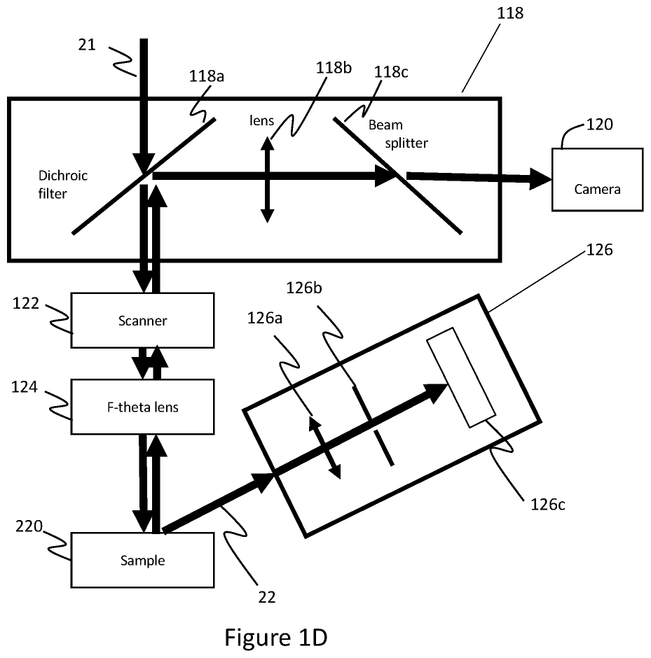

FIGS. 1A, 1B and 1C illustrate a block diagram of an apparatus according to embodiments described herein that uses a pulsed laser that is focused onto and scanned across the surface of an advanced package sample for the purpose of removing material by laser ablation to create a cross-sectional view of the sample. After ablation, the sample can be imaged in a microscope, such as x-ray or electron microscope, and/or analyzed by a spectroscopic method. FIG. 1A shows, primarily, the pulsed laser components and FIG. 1B shows the components associated with the handling of a sample and FIG. 1C shows details of an exemplary arrangement for confocal sensing of ablation depth in the context of the exemplary system of FIGS. 1A and 1B.

With reference to FIG. 1A, following the primary components in the laser beam path, are a pulsed laser 10, an attenuator 12, a “top-hat” beam-shaper 14, a beam expander 16 and an alignment fixture 18. The pulsed laser 10 may exhibit variable control over laser power, pulse length, repetition rate, and a mechanical shutter. Types of pulsed lasers include solid state mode-locked lasers, solid state Q-switched lasers, and fiber mode-locked lasers. The pulsed laser 10 may also support multiple wavelengths via frequency doubling crystals. The optional top hat beam-shaper 14 converts a Gaussian beam profile to a pseudo-top hat profile. The top hat beam-shaper can be used to improve illumination uniformity across a sample surface. The attenuator 12 can be included if the laser 10 does not have fine enough control over the output power. If the attenuator 12 is used, the unused light is deflected into a beam dump and power meter 22. The beam expander 16 changes the diameter of the laser beam profile to match the entrance aperture of the scanner, which is detailed in FIG. 1B. Adjusting the beam diameter also helps determine the spot size at the sample. The alignment fixture 18 comprises a set of apertures that the laser beam is aligned to. If the beam drifts at the laser 10, it can be aligned to the alignment fixture and the rest of the beam path after the alignment fixture will not have to be aligned. Also shown in FIG. 1 are mirrors 24, 26, 28, 30 and 32 that are arranged to position the laser beam advantageously to the various components in the apparatus.

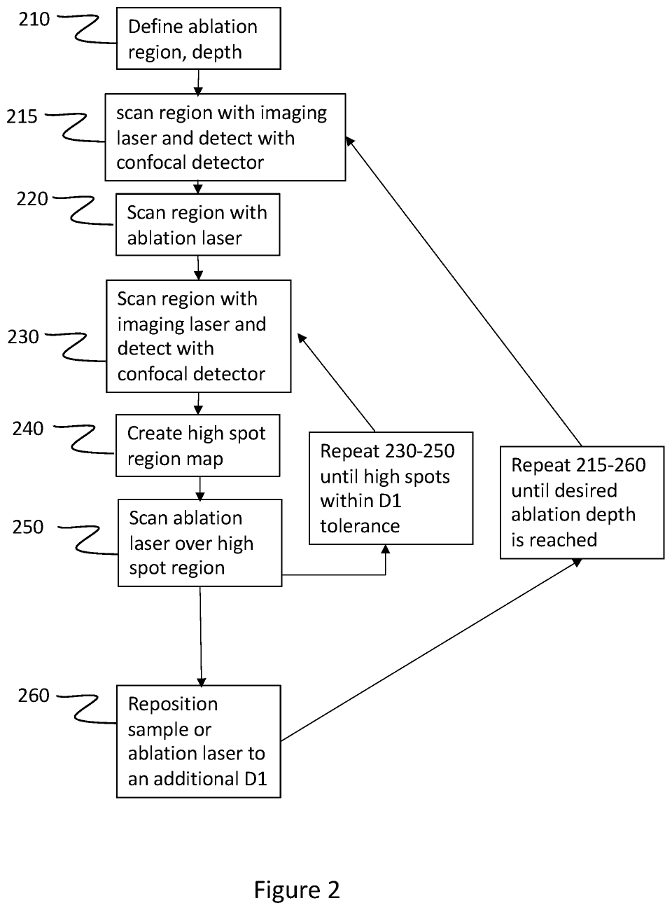

FIG. 1B shows a scan platform 100, which the laser beam from the components described in FIG. 1 enters at an alignment fixture 112. This alignment fixture serves as a reference point for the components in FIG. 2, so that once the position of the beam entering the alignment fixture 112 needs is adjusted the beam is then aligned as to all of the components downstream of this alignment fixture. 112. Following the alignment fixture 112 is a circular polarizer 114. The circular polarizer 114 is a waveplate that converts the beam from linearly polarized light to circularly polarized light. This is useful for ablating certain metals and other crystals that have a dependence between ablation speed and crystal orientation.

In some embodiments, a focus module 116 may be included in the beam path. The focus module 116 comprises a motorized optical element that can shift the focal position of the laser beam at the sample. A focus module 116 can be used in place of a motorized z-stage at the sample. Following the focus module 116 (or circular polarizer 114 if no focus module is used) is a camera module 118. In either case, there is a target ablation focal plane of the ablation laser z1. The actual ablation depth of the sample can typically extend approximately +/−one Rayleigh length about that target focal plane. Because of the uncertainty in actual ablation depth, a confocal sensing system is used to determine actual sample depth either before, after (or both) or concurrently with each ablation step. As shown schematically in FIG. 1B, the camera module 118 comprises a beam splitter to pass primary laser light to the sample and deflect light reflected from the sample into an in-line camera 120 or optional confocal detector 126 or optional spectrometer (not shown). The camera module 118 allows for through-the-lens imaging of the sample as well as optional height detection using a confocal detector 126 and spectroscopy of the plasma plume when these devices are included in the system.

Following the camera module is a scan head 122. The scan head 122 comprises two actuated mirrors to scan the laser beam in orthogonal directions at the sample surface. Alternatively the scan head can comprise a rotating polygon mirror. Following the scan head 122, is an F-theta lens 124, which focuses the laser beam onto the sample surface. An F-theta lens allow the laser beam to be scanned while maintaining focus across the field of view, however, a different type of lens may be used if a reduced field of view is acceptable.

FIG. 1B also shows a five-axis sample stage 210 on which a sample rests for laser ablation by the apparatus. In some embodiments, the sample stage 210 includes a mechanism to move the sample between the process position, an off-line microscope position, and a loading position. The sample stage 210 also moves different regions of the sample into the process position and sets the height of the sample so the region of interest is in the focal plane. The sample stage 210 can also tip and tilt a sample. As shown, the sample stage 210 may also include a liquid bath 220 for cooling the sample during ablation. The liquid in the bath may be sourced by a reservoir and pump 226. During ablation, the fluid from reservoir and pump 226 may be circulated through a filter 224 by a circulation pump 222. A fume extractor 216 is included to safely remove vaporized products of ablation, and optionally for analysis. A gas jet 214 may be provided to remove ablated material during a cut. FIG. 1B also shows an off-axis optical microscope 300, which may be an optical microscope or an electron microscope. In an embodiment of the invention, the 5-axis stage 210 is located to enable transfer of the sample for viewing in the microscope 300.

FIG. 1C shows an arrangement for confocal sensing of ablation depth consistent with implementations described herein. As shown, imaging laser beam 21 illuminates the sample and produces reflected light which is sensed to determine ablation depth at the spot illuminated by the imaging laser beam 21. The imaging laser beam 21 may be a beam from the alignment laser 20 discussed above, or may be from a separate laser not shown in the Figures, or may be a light source other than a laser such as one or more light emitting diodes or or other light sources. Regardless of the source of the imaging laser beam, the imaging laser beam 21 is directed to enter the camera module 118 aligned on the same axis as the ablation laser beam. The camera module 118 includes a dichroic filter 118a, a lens 118b and a beam splitter 118c. The beam splitter directs a portion of the imaging laser beam to a confocal sensor 126 and another portion of the imaging laser beam to a camera 120. As shown in FIG. 1C, confocal sensor 126 includes a lens 126a, a pin hole (aperture) 126b, and a detector 126c.

In a further embodiment, the ablation laser operating at a reduced power level may be used as an imaging light source. In this case, because a wavelength specific filter cannot be used to protect the confocal sensor from the full powered ablation laser, a shutter may be included to block light to the confocal sensor when the ablation laser is operating at an ablation power level.

Light from the imaging laser beam 21 that is reflected or scattered from the sample passes back through the f-theta lens 124. The reflected light is directed by a mirror/optical filter 118a to remove background light from the plasma and/or primary laser, then imaged by a second lens 126a, focused through an aperture 126b, and measured by a detector 126c in a confocal arrangement. The confocal imaging components are arranged to detect material within a fixed depth above or below the focal plane. Typically this distance will be less than one Rayleigh length of the ablation laser.

According to an aspect of the invention, the detector 126c in confocal sensor 126 and the imaging laser beam are time-multiplexed with the ablation laser beam to suppress signal from the plasma plume and/or ablation laser.

The system further comprises a system controller for control of the ablation laser 10, the scan head 122, the sample stage 210 and the imaging laser 20 as well as to receive image data from the confocal detector 126c.

According to a further aspect of the invention shown in FIG. 1D, an off axis lens 126a may be used to direct scattered light 22 from the sample through an aperture 126b to a confocal detector 126c. In this aspect, the scattered light 22 that is detected by the confocal detector 126c does not pass through the f-theta lens 124. This arrangement of components allows for more room for the confocal detection components.

The size of the aperture 126b is determined such that the signal detected primarily arrived from a region within a fixed percentage of the Rayleigh length of the ablation laser at the sample surface. For example, if the Rayleigh length of the ablating beam is 200 microns, then one might detect material that is within +/−50 microns of the focal plane. The detection depth range is designated here as D1.

FIG. 2 is a flow chart of a process for measuring ablation depth during processing of a sample according to an aspect of the invention. Initially, at step 210, a region of the sample and total depth to be removed by the laser are determined. This can be any shape defined by the user. At step 215 an initial scan by the imaging laser and confocal sensor (or equivalent means as discussed herein) is made to determine the surface level of the sample over the entire region. This scan is made because between each ablating step it is necessary to determine the actual surface level as the ablation depth at each ablation pass may not be uniform across the sample. At step 220 the ablation laser is scanned at least once over the entire region to be removed. This scan can be repeated as many times as is required to remove material to a predetermined depth. At step 230, the imaging laser beam 21 is scanned over the entire region to be removed and reflected or scattered light from the sample is detected by the confocal detector 126c. Every position (spot) where the confocal signal indicates the sample surface is above a predetermined threshold for detection that corresponds to material not being at the predetermined depth is recorded by the system controller. At step 240, a new region is created that is composed only of those spots detected in step 230 (high spot regions). This can be implemented as a bitmap of the original region with nonzero pixels only in the spots detected as not sufficiently deep. Alternatively, the new region is implemented as one or more islands of detected high spots. At step 250, the ablating laser is scanned over the new region created in step 240. This can be implemented by scanning the entire original ablation region and turning on the laser only in the pixels detected by step 230, or by creating a new scan map that includes only those pixels. Steps 230-250 are repeated as many times as necessary until a predetermined minimum threshold of pixels are detected in step 230. This threshold can be set as a percentage of total pixels or a fixed number. At step 260, the sample is moved closer to the ablating laser beam by a distance of D1, or the focus (or physical position) of the ablating laser may be changed closer to the sample by D1. Steps 215-260 are repeated until the total desired ablation depth is reached.

According to an embodiment described herein, the ablation laser beam and imaging laser beam may be held in a fixed position while the 5-axis stage 210 is moved to mill a portion of the sample. In other embodiments, a combination of movement of the laser beam by the scan head 112 and movement of the 5-axis stage is used for milling the sample

According to embodiments described herein, the pulsed laser 10 is operated between 1 and 50 Watts of power. In addition, the wavelength of the pulsed laser may be between about 1050 nanometers (nm) and 350 nm. According to further aspects described herein, the pulse length is between 250 femotseconds (fs) and 750 picoseconds (ps). According to a further aspect, the pulsed laser has a spot size between 10 nm and 100 nm at the sample.

Consistent with embodiments described herein, the sample may be held under liquid, such as water, in the bath 220, with the top surface of the sample up to 1.5 mm under the surface of the liquid. A fluid recirculating system may include circulation pump 222 and filter 224 as described briefly above. Circulation pump 222 may operate to pump the liquid through filter 224 and maintain flow during processing so the liquid in bath 220 stays clear and to eliminate bubbles from the laser ablation process. The recirculating system may include a liquid level adjustment to compensate for different size samples and to remove all liquid in case a sample needs to be processed without the liquid. The recirculating system may include a capability to adjust the liquid level during processing based on either processing time or measured level to replace liquid lost by splattering or evaporation, as well as to keep the liquid level at a fixed height above the surface that is being ablated. This is necessary to keep the depth of liquid above the ablated surface constant while the level of the ablated surface is gradually lowered during the ablation process.

An additive may be added to the liquid in bath 220 so that the liquid “wets” the surface of the sample. In some implementations consistent with embodiments described herein, the additive may be an alcohol or a soap. This additive may also be chosen to reduce oxidation or selectively enhance ablation of the sample, such as a weak acid for reducing of metal oxidation.

In a further aspect, the laser may be paused to allow liquid to flow back into the ablated region. In a further aspect, a small region within a larger region to be milled is first milled entirely through the sample. This allows liquid to flow into the milling region from below the sample to cool the ablation region of the sample while the larger region is being milled.

According to another aspect, the pulsed laser operates in a burst mode, where a burst of pulses is continuously repeated at a fixed repetition rate. In an aspect of the invention, the number of pulses in each burst can vary between 2 and 50.

According to a yet another aspect, the system includes a spectrometer to analyze the plasma plume as extracted by the plume extractor 216. The spectrum analysis of the plasma plume is useful to determine the material being ablated. This can be used for ablation end point detection.

According to another aspect, the system includes a light detector, or a mirror and a light detector, located underneath the sample and protected by a layer of liquid (e.g., at a depth of >5 mm) to prevent ablation of the detector/mirror/window. The light detector or mirror/light detector operates to detect the end point of a cross section. The detector signal can be synchronized to the laser scanner system to create a shadow image of the cross-section edge. The light detector may not have any dimensional information, but by synchronizing the detection of light with the laser position, a 2D image can be created based on the raster effect of the laser beam scanning across the sample.

According to a further aspect of the invention, the power of the ablation laser is reduced enough that it does not significantly ablate, and it is used as the imaging laser instead of a separate imaging laser. For example, the ablation laser is operated to be at normal power and do an ablation scan (or scans) of the region, then is turned down in power to perform an imaging scan. Alternatively the laser could do two pulses at every spot, an ablation pulse at normal power then an imaging pulse at low power. In this case, a delay between the two pulses might be used to wait for the plasma plume to dissipate before the imaging pulse. Another possibility is an imaging pulse followed by an ablation pulse (or pulses), but only if the imaging pulse showed material that needs to be removed. This avoids the need to wait for the plasma plume to dissipate prior to performing the imaging pulse. A high speed shutter may be included ahead of the confocal sensor to avoid the sensor being exposed to reflections or scattered light when the full power of the ablation laser is turned on. A shutter would not be needed when a separate imaging laser is used if the imaging laser is a different wave length than the ablation laser. Instead, a filter is inserted ahead of the confocal sensor that allows the imaging laser wavelength light to pass and blocks the wavelength light of the ablation laser.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method for milling a region of a sample with an ablation laser beam to a first predetermined depth comprising:
a. performing a first scan of an ablation laser over the region of the sample;
b. scanning an imaging laser over the region of the sample and detecting light reflected or scattered by the sample with a confocal detector,
wherein said confocal detector is arranged to be in focus at said first predetermined depth and in a range based on the Rayleigh length of said ablation laser;
c. defining a second sample region which was not ablated to said first predetermined depth based on detecting of light reflected off of the sample; and
d. scanning the ablation laser over said second sample region to ablate sample portions not ablated to said first predetermined depth in said first scan of an ablation laser.

2. The method of claim 1 wherein steps a, b, c and d are repeated one or more times to mill the region of the sample to a final depth.

3. The method of claim 1, wherein said performing a first scan of an imaging laser occurs simultaneously with said scanning of an ablation laser and wherein said light reflected off of the sample is filtered to exclude light from said ablation laser.

4. The method of claim 1, wherein said scanning of an imaging laser occurs after said ablation laser has scanned the region.

5. The method of claim 1, wherein said ablation laser is pulsed on and off during said first scan and said scanning of an imaging laser occurs time multiplexed with said performing a first scan of said ablation laser such that said imaging laser is on for a portion of the time when said ablation laser is off.

6. The method of claim 1, wherein said confocal detector is arranged to receive light reflected off of the sample through an f-theta lens which is on axis with the ablation laser beam.

7. The method of claim 1, wherein said confocal detector is arranged to receive light scattered by the sample off axis from the ablation laser beam.

8. The method of claim 1, wherein said confocal detector comprises an aperture and wherein said aperture size is a predetermined factor of the of the Rayleigh length of the ablation laser at the sample surface.

9. The method of claim 1, further comprising scanning said imaging laser over the region of the sample and detecting light reflected or scattered by the sample with said confocal detector, prior to each ablation step.

10. A system for milling a region of a sample with an ablation laser beam to a first predetermined depth comprising:
an ablation laser that produces the ablation laser beam having an ablation plane and a target ablation depth about said ablation plane;
an imaging light source that produces an imaging illumination;
a confocal detector having an aperture and a sensor; and
a beam scanner;
wherein said ablation laser beam and said imaging illumination are directed to said sample through said beam scanner and wherein said confocal detector is arranged to receive light from said imaging source reflected or scattered by of the sample, said light from said imaging source arranged to be in focus at said confocal detector when said imaging source is directed to a portion of the surface of the sample that has been milled to a predetermined depth by said ablation laser.

11. The system of claim 10, wherein said beam scanner is arranged to scan said ablation laser beam and said imaging illumination over a predefined region of the sample.

12. The system of claim 10, further comprising an f-theta lens wherein said ablation laser beam and said imaging illumination pass through said f-theta lens.

13. The system of claim 12, wherein said confocal sensor is arranged to receive light from said imaging source reflected by the sample via said f-theta lens.

14. The system of claim 12, wherein said confocal sensor is arranged to receive light from said imaging laser source reflected or scattered by the sample and not via said f-theta lens.

15. The system of claim 10 further comprising a system controller wherein said system controller is configured to:
a. perform a first scan via said beam scanner of said ablation laser beam over the region of the sample;
b. scan said imaging illumination via said beam scanner over the region of the sample and detect light reflected off of the sample with a confocal detector wherein said confocal detector is arranged to be in focus at said first predetermined depth and over a focal range based on the Rayleigh length of the ablation laser;
c. define a second sample region which was not ablated to said first predetermined depth based on said detection of light reflected off of the sample; and
d. scan the ablation laser beam via said beam scanner over said second sample region to ablate sample portions not ablated to said first predetermined depth in said first scan of the ablation laser beam.

16. The system of claim 15 wherein said system controller repeats steps a, b, c and d one or more times to mill the region of the sample to a final depth.

17. The system of claim 15, wherein said system controller causes said first scan of the imaging illumination to occur simultaneously with said scan of the ablation laser beam and wherein said light reflected off of the sample is filtered to exclude light from said ablation laser beam.

18. The system of claim 15, wherein said system controller causes said scan of the imaging illumination to occur after said ablation laser beam has scanned the region.

19. The system of claim 16, wherein said system controller causes the ablation laser beam to be pulsed on and off during said first scan and to cause said scanning of the imaging illumination to occur time multiplexed with said first scan of said ablation laser beam such that said imaging illumination is on for a portion of the time when said ablation laser beam is off.

20. The system of claim 15, wherein said confocal detector is arranged to receive light reflected off of the sample through an f-theta lens which is on axis with the ablation laser beam.

21. The system of claim 15, wherein said confocal detector is arranged to receive light reflected or scattered by the sample off axis from the ablation laser beam.

22. The system of claim 10, wherein said imaging light source is a laser, light emitting diode or the ablation laser.
